(19) United States
(12) Patent Application Publication
(10) Pub. No.: US 2004/0237001 A1
(43) Pub. Date: Nov. 25, 2004

(54) Memory integrated circuit including an error detection mechanism for detecting errors in address and control signals

(75) Inventors: Jurgen M. Schulz, Pleasanton, CA (US); Chung-Hsiao R. Wu, Sunnyvale, CA (US)

Correspondence Address: MEYERTONS, HOOD, KIVLIN, KOWERT & GOETZEL, P.C., P.O. BOX 398, AUSTIN, TX, 78767-0398, US

(73) Assignee: Sun Microsystems, Inc.

(21) Appl. No.: 10/442,842

(22) Filed: May 21, 2003

(51) Int. Cl. H04B 1/74

(52) U.S. Cl. 714/42

(57) ABSTRACT

A memory integrated circuit including an error detection mechanism for detecting errors in address and control signals. The memory integrated circuit includes a memory array including a plurality of memory cells configured to store data. The memory integrated circuit also includes an address logic unit coupled to the memory array which may be configured to receive a plurality of memory requests each including address information and corresponding error detection information. The corresponding error detection information may be dependent upon the address information. The memory integrated circuit further includes error detection logic which is coupled to the address logic and may be configured to detect an error in the address information based upon the corresponding error detection information and may provide an error indication in response to detecting the error.

### BACKGROUND OF THE INVENTION

1. Field of the Invention

This invention relates to computer system reliability and, more particularly, to the detection of errors in memory integrated circuits of memory subsystems.

2. Description of the Related Art

Computer systems are typically available in a range of configurations which may afford a user varying degrees of reliability, availability and serviceability (RAS). In some systems, reliability may be paramount. Thus, a reliable system may include features designed to prevent failures. In other systems, availability may be important and so systems may be designed to have significant fail-over capabilities in the event of a failure. Either of these types of systems may include built-in redundancies of critical components. In addition, systems may be designed with serviceability in mind. Such systems may allow fast system recovery during system failures due to component accessibility. In critical systems, such as high-end servers and some multiple processor and distributed processing systems, a combination of the above features may produce the desired RAS level.

Depending on the type of system, data that is stored in system memory may be protected from corruption in one or more ways. One such way to protect data is to use error detection and/or error correction codes (ECC). The data may be transferred to system memory with an associated ECC code which may have been generated by a sending device. ECC logic may then regenerate and compare the ECC codes prior to storing the data in system memory. When the data is read out of memory, the ECC codes may again be regenerated and compared with the existing codes to ensure that no errors have been introduced to the stored data.

In addition, some systems may employ ECC codes to protect data that is routed through out the system. However, in systems where a system memory module such as a dual in-line memory module (DIMM), for example, is coupled to a memory controller, the data bus and corresponding data may be protected as described above but the address, and control information and corresponding wires may not. In such systems, a bad bit or wire which conveys erroneous address or command information may be undetectable as such an error. For example, correct data may be stored to an incorrect address or data may not be actually written to a given location. When the data is read out of memory, the ECC codes for that data may not detect this type of error, since the data itself may be good. When a processor tries to use the data however, the results may be unpredictable or catastrophic.

### SUMMARY OF THE INVENTION

Various embodiments of a memory device including an error detection mechanism for detecting errors in address and control signals are disclosed. In one embodiment, a memory integrated circuit includes a memory array including a plurality of memory cells configured to store data. The memory integrated circuit also includes an address logic unit coupled to the memory array which may be configured to receive a plurality of memory requests each including address information and corresponding error detection information. The corresponding error detection information may be dependent upon the address information. The memory integrated circuit further includes error detection logic which is coupled to the address logic and may be configured to detect an error in the address information based upon the corresponding error detection information and may provide an error indication in response to detecting the error.

In another embodiment, a memory integrated circuit includes a memory array including a plurality of memory cells configured to store data. The memory integrated circuit also includes a command control logic unit coupled to the memory array which may be configured to receive a plurality of memory requests each including control information and corresponding error detection information. The corresponding error detection information may be dependent upon the control information. The memory integrated circuit further includes error detection logic which is coupled to the command control logic and may be configured to detect an error in the control information based upon the corresponding error detection information and may provide an error indication in response to detecting the error.

### BRIEF DESCRIPTION OF THE DRAWINGS

FIG. 1 is a block diagram of one embodiment of a computer system.

FIG. 2 is a block diagram of one embodiment of a memory subsystem.

FIG. 3 is a block diagram of one embodiment of a memory module.

FIG. 4 is a block diagram of one embodiment of a memory integrated circuit.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

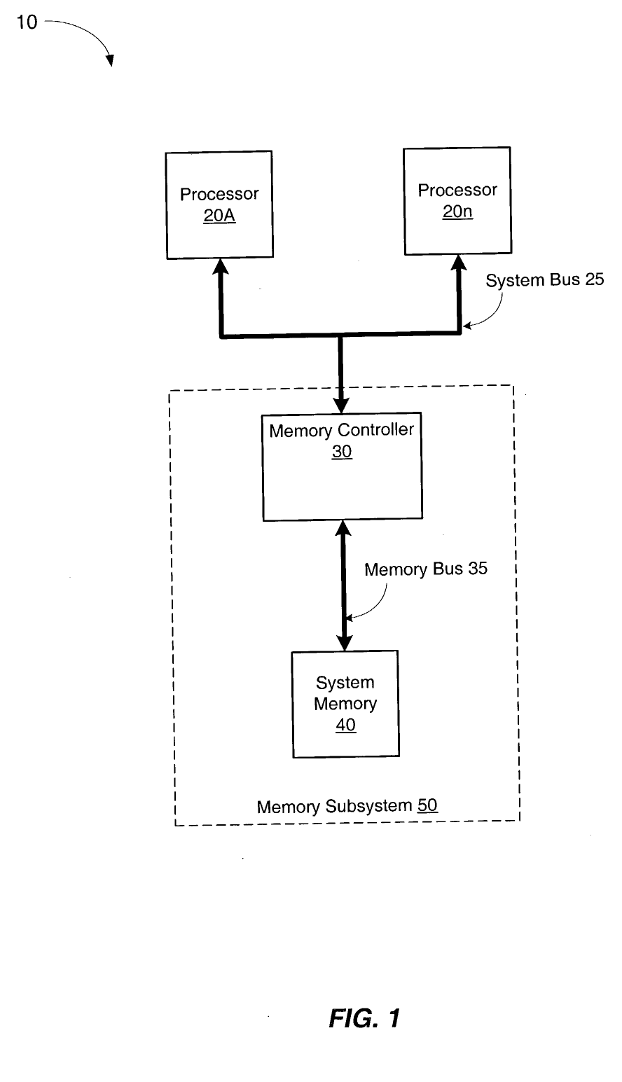

Turning now to FIG. 1, a block diagram of one embodiment of a computer system 10 is shown. Computer system 10 includes a plurality of processors 20-20n connected to a memory subsystem 50 via a system bus 25. Memory subsystem 50 includes a memory controller 30 coupled to a system memory 40 via a memory bus 35. It is noted that, although two processors and one memory subsystem are shown in FIG. 1, embodiments of computer system 10 employing any number of processors and memory subsystems are contemplated. In addition, elements referred to herein with a particular reference number followed by a letter may be collectively referred to by the reference number alone. For example, processor 20A-n may be collectively referred to as processor 20.

Memory subsystem 50 is configured to store data and instruction code within system memory 40 for use by processor 20. As will be described further below, in one embodiment, system memory 40 may be implemented using a plurality of memory modules such as dual in-line memory modules (DIMM), for example. Each memory module may employ a plurality of memory chips which may belong to the dynamic random access memory (DRAM) family of memory chips. For example, in one embodiment, double data rate synchronous DRAM (DDRSDRAM) chips may be used. It is contemplated, however, that other types of memory may be used. Each memory module may be mated to a system memory board via an edge connector and socket arrangement. The socket may be located on a memory subsystem circuit board and each memory module may have an edge connector which may be inserted into the socket, for example.

In another embodiment, it is contemplated that system memory 40 may be implemented using a plurality of memory modules which may be mated to a system memory board such that the memory modules are not removable by a user. For example, the memory modules may be soldered or otherwise more permanently mounted to the system memory board.

In yet another embodiment, it is contemplated that the logic that is typically associated with and included on a memory module may be located directly on a system memory board. In such an embodiment, the circuitry may be logically divided into modules on the system memory board.

Generally speaking, processor 20 may access memory subsystem 50 by initiating a memory request transaction such as a memory read or a memory write to memory controller 30 via system bus 25. Memory controller 30 may then control the storing to and retrieval of data from system memory 40 by issuing memory request commands to system memory 40 via memory bus 35. Memory bus 35 conveys address and control information as well as data to system memory 40. In one embodiment, the address and control information may be conveyed from memory controller 30 to each memory module in a point-to-multipoint arrangement while the data may be conveyed between memory controller 30 and each memory chip on each memory module in a point-to-point arrangement.

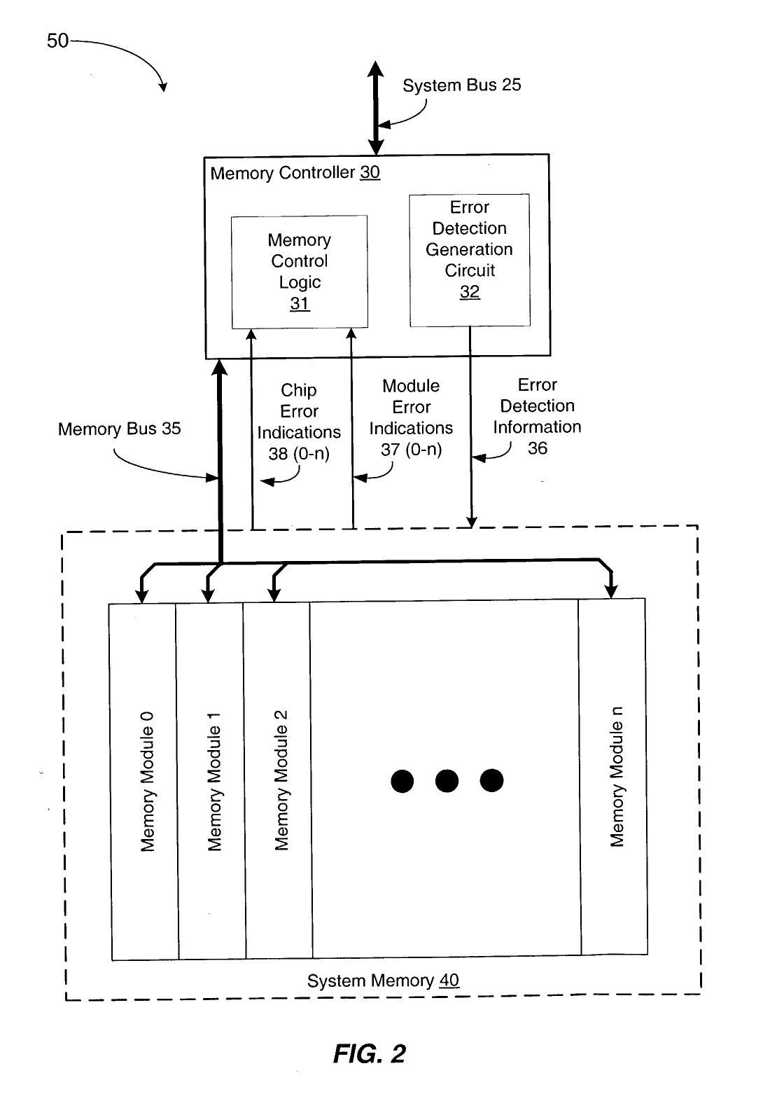

Referring to FIG. 2, a block diagram of one embodiment of a memory subsystem is shown. Circuit components that correspond to components shown in FIG. 1 are numbered identically for clarity and simplicity. In FIG. 2, memory subsystem 50 includes a memory controller 30 coupled to a system memory 40 via a memory bus 35. Memory controller 30 includes a memory control logic unit 31 and an error detection generation circuit 32. In addition to memory bus 35, additional signals may be conveyed between memory controller 30 and system memory 40. In the illustrated embodiment, error detection information 36, module error indications 37 and chip error indications 38. As mentioned above, system memory 40 includes a plurality of memory modules depicted as memory modules 0 through n, where n is representative of any number of memory modules. It is noted that similar to the data signals, each memory module may convey an independent module error indication and an independent chip error indication signal to memory controller 30. However, error detection information 36 may be conveyed in a point-to-multipoint arrangement similar to the address and control signals. Accordingly, the signals representing module error indications 37 and chip error indications 38 are each shown with a (0-n) designation.

It is noted that in one embodiment, memory bus 35 may convey address and control information in packets. In such an embodiment, the error detection information may protect the address and control information conveyed in each packet.

However in an alternative embodiment, it is contemplated that memory bus 35 may convey address, control and error detection information in a conventional shared bus implementation. In such an embodiment, the error detection information may protect the address and control information during each address and/or clock cycle.

In the illustrated embodiment, memory controller 30 may receive a memory request via system bus 25. Memory controller logic 31 may then schedule the request and generate a corresponding memory request command for transmission on the address and control portion of memory bus 35. In one embodiment, the address signals may include address A0-A13 and bank control signals BA0-BA1. The control signals may include a row address strobe (RAS), a column address strobe (CAS), a write enable (WE) and a chip select (CS) signal. The address and control signals may be encoded into various memory commands such as read and write. For example, if a memory request is a memory read, memory control logic 31 may generate a read request that includes the requested starting address within system memory 40 and corresponding control information such as such as a start-read command. It is noted that one or more of the above signals may be active low signals.

In addition to the address and control information, the request may include error detection information 36 such as parity information, for example. In such an embodiment, error detection information 36 may include one or more parity bits which are dependent upon and protect the address and control information that is transmitted from the memory controller 30 to the memory module(s). It is noted that similar to the address and control information, the error detection information may be sent to each memory module in a point-to-multipoint arrangement. Error detection generation circuit 32 may be configured to generate error detection information 36. It is noted that in an alternative embodiment, error detection information 36 may be transmitted independently of the request. It is noted that in other embodiments, error detection information 36 may include other types of error detection codes such as a checksum or a cyclic redundancy code (CRC), for example. Further, it is noted that in yet other embodiments, the error detection information may be an error correction code such as a Hamming code, for example. In such an embodiment, error detection circuit 130 may be configured to detect and correct errors associated with received memory requests.

In the illustrated embodiment, system memory 40 includes memory module 0 through memory module n. Depending on the system configuration, the memory modules may be grouped into a number of memory banks such that a given number of modules may be allocated to a given range of addresses. Each address and control signal of memory bus 35 may be coupled to each of memory modules 0 through n. Control logic (not shown in FIG. 2) within each memory module may control which bank responds to a given memory request. It is noted that in an alternative embodiment, the address and control signals may be duplicated and routed among the memory modules to reduce loading effects.

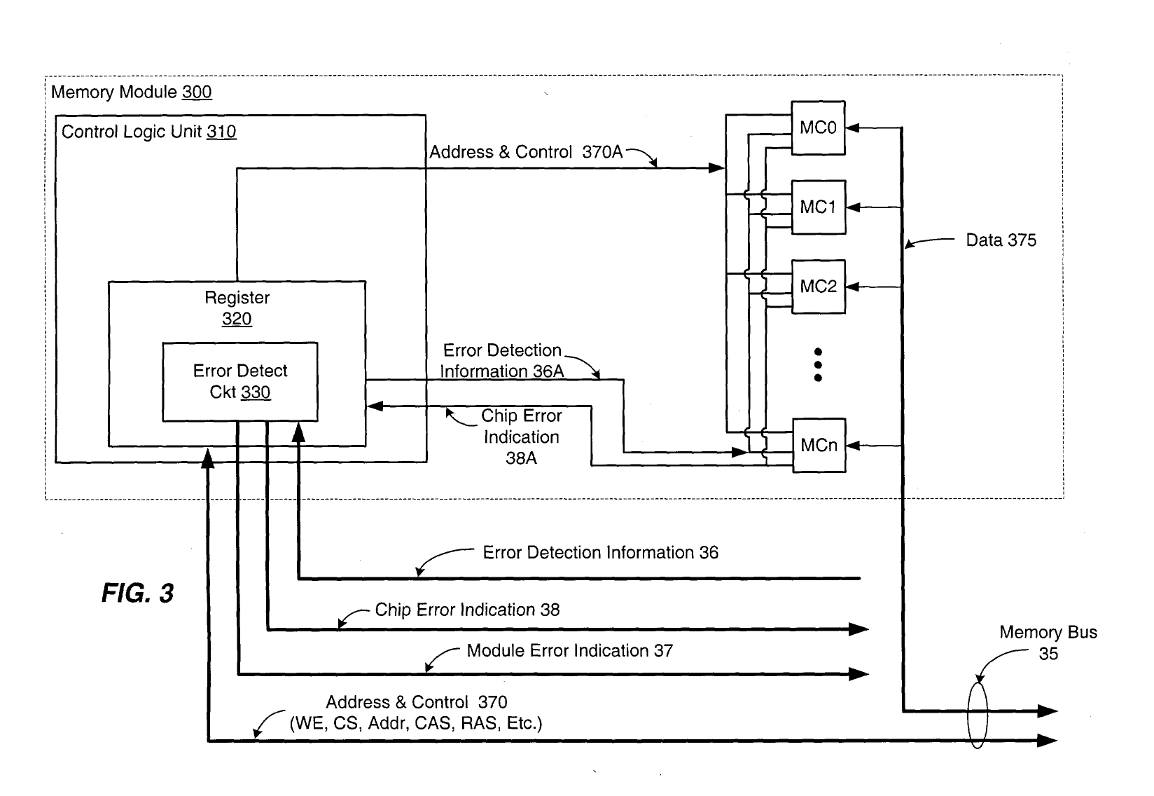

As will be described in greater detail below in conjunction with the description of FIG. 3, each of memory modules 0-n may generate a module-level error indication 37 and a memory chip-level error indication 38 in response to detecting an error in the address and control information conveyed on memory bus 35, thereby providing end-to-end protection of the address and control signals. It is noted that in a conventional DRAM, there may be no way to detect that a configuration write is the cause of an error, since the mode set registers are generally not readable. However the end-to-end protection provided by module-level error indication 37 and memory chip-level error indication 38 may also extend to configuration writes of the mode set registers within a DRAM chip because the configuration writes share the same address and control signals as a normal write.

Turning to FIG. 3, a block diagram of one embodiment of a memory module is shown. Memory module 300 includes a control logic unit 310 which is coupled to a plurality of memory chips, designated MC 0-n, where n may be any number. Memory bus 35 conveys address and control information 370 and data 375 to memory module 300. The data path 375 is routed to memory chips 0-n. Control logic unit 310 includes a register 320. Register 320 includes an error detection circuit 330. Address and control signals 370 are routed to register 320. Error detection information 36 is routed to error detection circuit 330. In addition, chip error indication 38 and module error indication 37 are each routed from error detection circuit 330. Further, chip error indication 38A and error detection information 36A are routed between each memory chip and error detection circuit 330. It is noted that each of memory chips 0-n may output a chip error indication 38A and in one embodiment, the signals 38A may be combined in a wired-OR configuration. Although other embodiments are contemplated in which each chip error indication 38A may be routed to control logic unit 310 to provide additional diagnostic functionality. As used herein, a “memory chip” refers to a memory device manufactured as an integrated circuit on a semiconducting substrate used for storing information. The memory device may be encapsulated in an integrated circuit package with external connections for connection to a circuit board.

It is noted that although one register 320 is shown, alternative embodiments are contemplated in which more than one register 320 and more than one error detection circuit 330 may be used. In such embodiments, any additional registers 320 may be cascaded or each may be configured to receive portions of address and control signals 370 and to generate corresponding portions of the address and control signals for memory chips 0-n. Further, additional registers 320 may be configured to generate a partial error detection information and to pass that partial error detection information to one of registers 320, which calculates the full error detection information.

It is noted that in further alternative embodiments are contemplated in which combinatorial logic which is not included in register 320 may be configured to combine the partial error detection information. In yet another embodiment, the partial error detection information may be sent separately on multiple wires of memory bus 35.

In the illustrated embodiment, MC 0-n may be implemented in various versions of DDRSDRAM technology such as DDR2, for example. Although it is noted that in other embodiments, MC 0-n may be implemented in other types of DRAM. In embodiments employing other types of DRAM, other address and control signals (not shown) may be used.

Generally speaking, to access a DDRSDRAM device, a command encoding and an address must first be applied to the control and address inputs, respectively. The command may be encoded using the control inputs. The address is then decoded, and data from the given address is accessed or the data received on the input data pins is written to the decoded address, typically in a burst mode.

In the illustrated embodiment, control logic unit 310 may receive memory request command encodings from a memory controller such as memory controller 30 of FIG. 2, via memory bus 35. As described above, the memory request command may be encoded using address and control information 370 (e.g., RAS, CAS, WE and CS signals). Each received request may be temporarily stored in register 320. Depending upon the banking arrangement of memory chips 0-n, control logic unit 310 may generate appropriate control signals for accessing the appropriate bank of memory chips by generating various WE and CS signals in addition to the Addr signals. It is noted that control logic unit 310 may generate other signals (not shown) which may control MC 0-n but have been left out for simplicity. A more detailed description of the general operation of a DDRSDRAM device may be found in the JEDEC standard JESD79 entitled “Double Data Rate (DDR) SDRAM Specification” available from the JEDEC Solid State Technology Association.

In the illustrated embodiment, error detection circuit 330 calculates new error detection information based upon the address and control information 370 received in a current memory request and stored in register 320. In a subsequent clock cycle, error detection circuit 330 may receive error detection information 36 corresponding to the current memory request from a memory controller such as memory controller 30 of FIG.2. Error detection circuit 330 compares the new error detection information to the received error detection information 36 to determine if there is an error present in the address and control information 370 of the current request. If an error is detected, error detection circuit 330 may generate a module error detection indication 37. In one embodiment, module error detection indication 37 may be stored until a subsequent clock cycle, while in other embodiments module error detection indication 37 may be sent to memory controller 30 immediately. It is noted that error detection circuit 330 may be implemented in any of a variety of circuits such as combinatorial logic, for example.

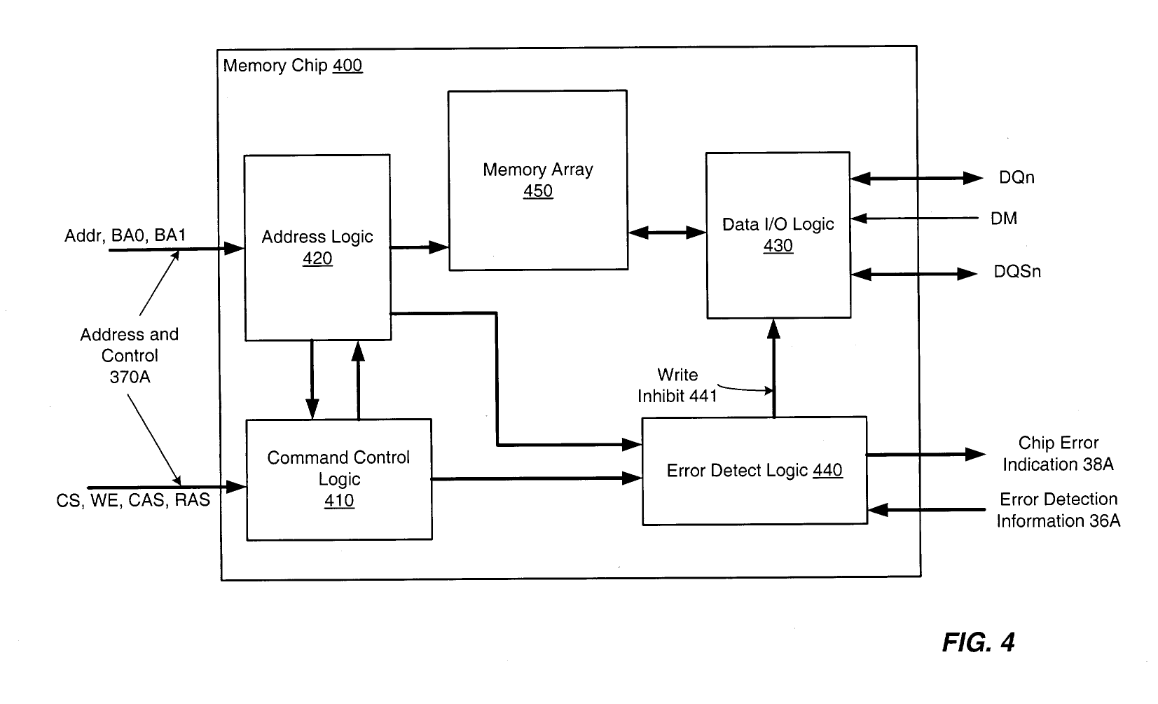

Error detection circuit 330 is also configured to send the received error detection information 36 to each of memory chips 0-n as error detection information 36A. Register 320 is also configured to forward the address and any control signals to each of memory chips 0-n as address and control 370A. As will be described in greater detail below in conjunction with the description of FIG. 4, each memory chip may include functionality to also detect errors in address and control information 370A and to return a chip error indication 36A to register 320. Register 320 may notify memory controller 30 of the chip error by forwarding chip error indication 36 to memory controller 30.

Referring to FIG. 4, a block diagram of one embodiment of a memory integrated circuit is shown. Memory chip 400 includes command control logic 410 which is coupled to address logic 420. Address logic 420 is coupled to a memory array 450. Memory chip 400 also includes data input/output (I/O) logic 430 which is also coupled to memory array 450. Further, memory chip 400 includes error detect logic 440 which is coupled to data I/O logic 430 and to command control logic 410 and address logic 420. It is noted that memory chip 400 is an example of any of memory chips MC 0-n of FIG. 3.

Memory chip 400 receives address information such as address signals A0-A13 and BA0-BA1, for example, into address logic 420. Address logic 420 may be configured to decode the row and column address and to multiplex the appropriate signals for enabling the rows and columns of memory array 450 during memory accesses.

Memory chip 400 receives control information such as WE, RAS, CAS and CS, for example, into command control logic 410. Command control logic 410 is configured to decode the control information into various commands as described above.

Memory chip 400 receives and outputs data on data (DQn) pins and receives and drives data strobe signals on data strobe (DQSn) pins. Data I/O logic 430 may include I/O drivers (not shown) for driving output data which has been read from memory array 450. Further, data I/O logic 430 may include receive logic and buffers (not shown) for latching input data which is being written into memory array 450. In addition, data I/O logic 430 may be configured to inhibit writing received data into memory array 450 in response to receiving an active data mask (DM) signal or an equivalent inhibit signal while data is being received.

Error detect logic 440 is configured to generate new error detection information based upon the received address and control information 370A. Error detect logic 440 is further configured to receive error detection information 36A and to compare the received error detection information 36A to the newly generated error detection information. In one embodiment, if an error is detected in the received address and control information 370A, error detect logic 440 is configured to indicate the presence of the error by generating a chip error indication 38A.

In addition, as will be described further below, if the current memory request is a write request, error detection logic 440 may further provide a write inhibit signal 441 to data I/O logic 430 which may cause the write data not to be written into memory array 450. In one embodiment, write inhibit 441 may cause logic within data I/O logic 440 (not shown) to inhibit the write data, similar to the masking operation caused by an active DM signal.

Referring collectively to FIG. 2 through FIG. 4, if an address and control signal error is detected and the current memory request is a read, error detection circuit 330 may send the appropriate error indications 37 and 38 to memory controller 30 and in one embodiment, control logic unit 310 of FIG. 3 may not return any data. In response to receiving either of error indications 37 or 38, memory control logic 31 of FIG. 2 may return a predetermined data value to processor 20 in response to receiving the error indication. Thus, in one embodiment, processor 20 may systematically abort any process which depends on that particular data. In one embodiment, the predetermined data value may be a particular data pattern that processor 20 may recognize as possibly erroneous data. In an alternative embodiment, the data may be accompanied by a bit which identifies to processor 20 that the data has an error.

If the current memory request is a write, error detection logic 440 of memory chip 400 may cause the write to be inhibited and error detection circuit 330 of memory module 300 may send error indications 37 and 38 to memory controller 30, thus notifying memory controller 30 that an error exists in the address and control signals of the current memory write request.

It is noted that in other embodiments, memory controller 30 may transmit both the module error indication 37 and chip error indication 36 to processor 20 of FIG. 1 or to a diagnostic subsystem (not shown) to indicate the presence of an error.

Depending on the configuration of system memory 40, the error may be isolated to a particular memory module, signal trace or wire. In one embodiment, the diagnostic processing subsystem may determine the cause of the error. In embodiments employing both the module error indication 37 and the chip error indication 38, the diagnostic subsystem may determine whether the error is between memory controller 30 and a memory module or between a memory chip and control logic unit 310 on a given memory module. The diagnostic processing subsystem may further isolate and shut down the failing component, or the diagnostic processing subsystem may reroute future memory requests. In other embodiments, the diagnostic subsystem may determine the cause of the error and run a service routine which may notify repair personnel.

In one embodiment, memory control logic 31 receives module error indication 37 or chip error indication 38 from system memory 40. In response to receiving an error indication, memory control logic 31 may store status information such as the address being written to or read from and the error indication, for example. The status information may be used in determining the cause of the error. In addition, memory control logic 31 may issue an interrupt to the diagnostic processing subsystem (not shown) or alternatively to processor 20.

It is noted that in various other embodiments, the address and control signal error detection mechanism employed by each of memory chips 0-n may be used independently of the address and control signal error detection mechanism employed within register 320 of memory module 300. In such embodiments, control logic unit 310 of FIG. 3 may simply receive and pass the error detection information 36 to each memory chip and forward any chip error indication 38A to memory controller 30.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A memory integrated circuit comprising:
a memory array including a plurality of memory cells configured to store data;
an address logic unit coupled to said memory array and configured to receive a plurality of memory requests each including address information and corresponding error detection information dependent upon said address information; and
error detection logic coupled to said address logic unit and configured to detect an error in said address information based on said corresponding error detection information and to provide an error indication in response to detecting said error.

2. The memory integrated circuit as recited in claim 1, wherein each of said plurality of memory requests further includes control information and said corresponding error detection information is further dependent upon said control information.

3. The memory integrated circuit as recited in claim 2, wherein said control information includes a write enable signal, a chip select signal, a row address strobe signal and a column address strobe signal.

4. The memory integrated circuit as recited in claim 2, wherein said corresponding error detection information includes a parity bit.

5. The memory integrated circuit as recited in claim 2, wherein said corresponding error detection information is an error correction code.

6. The memory integrated circuit as recited in claim 2, wherein said error detection logic is further configured to generate a second error detection information based upon said address information and said control information and to compare said second error detection information to said corresponding error detection information to detect said error.

7. The memory integrated circuit as recited in claim 6, wherein said error detection logic is further configured to inhibit data from being written to said memory array within a given memory chip in response to detecting said error.

8. A memory module comprising:
a circuit board including an edge connector for mating with a socket; and
a plurality of memory integrated circuits mounted on said circuit board, wherein said plurality of memory integrated circuits is configured to store and retrieve data in response to receiving a plurality of memory requests each including address information and corresponding error detection information dependent upon said address information;
wherein each of said plurality of memory integrated circuits includes error detection logic configured to detect an error in said address information based on said corresponding error detection information and to provide an error indication in response to detecting said error.

9. The memory module as recited in claim 8, wherein each of said plurality of memory requests further includes control information and said corresponding error detection information is further dependent upon said control information.

10. The memory module as recited in claim 9, wherein said corresponding error detection information includes a parity bit.

11. The memory module as recited in claim 9, wherein said corresponding error detection information is an error correction code.

12. The memory module as recited in claim 9, wherein said error detection logic is further configured to generate a second error detection information based upon said address information and said control information and to compare said second error detection information to said corresponding error detection information to detect said error.

13. The memory module as recited in claim 12, wherein said error detection logic is further configured to inhibit data from being written to a memory array within a given memory integrated circuit in response to detecting said error.

14. The memory module as recited in claim 8, wherein the memory module is a dual in-line memory module.

15. A memory integrated circuit comprising:
a memory array including a plurality of memory cells configured to store data;
a command control logic unit coupled to said memory array and configured to receive a plurality of memory requests each including control information and corresponding error detection information dependent upon said control information; and
error detection logic coupled to said command control logic unit and configured to detect an error in said control information based on said corresponding error detection information and to provide an error indication in response to detecting said error.

16. The memory integrated circuit as recited in claim 15, wherein said corresponding error detection information includes a parity bit.

17. The memory integrated circuit as recited in claim 15, wherein said corresponding error detection information is an error correction code.

18. The memory integrated circuit as recited in claim 15, wherein said error detection logic is further configured to inhibit data from being written to said memory array in response to detecting said error.

19. The memory integrated circuit as recited in claim 15, wherein said control information includes a write enable signal, a chip select signal, a row address strobe signal and a column address strobe signal.

20. A memory module comprising:
a circuit board including an edge connector for mating with a socket; and
a plurality of memory integrated circuits mounted on said circuit board, wherein said plurality of memory integrated circuits is configured to store and retrieve data in response to receiving a plurality of memory requests each including control information and corresponding error detection information dependent upon said control information;
wherein each of said plurality of memory integrated circuits includes error detection logic configured to detect an error in said control information based on said corresponding error detection information and to provide an error indication in response to detecting said error.

21. The memory module as recited in claim 20, wherein said corresponding error detection information includes a parity bit.

22. The memory module as recited in claim 20, wherein said corresponding error detection information is an error correction code.

23. The memory module as recited in claim 20, wherein said error detection logic is further configured to inhibit data from being written to a memory array within a given memory integrated circuit in response to detecting said error.

24. The memory module as recited in claim 20, wherein said control information includes a write enable signal, a chip select signal, a row address strobe signal and a column address strobe signal.

25. A method of detecting an error in a memory request including address and control information, said method comprising:
a memory integrated circuit receiving said memory request including error detection information dependent upon said address and control information;
said memory integrated circuit detecting an error in said address information and control information based on said corresponding error detection information and providing an error indication in response to detecting said error.

26. A memory integrated circuit comprising:
means for receiving a memory request including address and control information and corresponding error detection information dependent upon said address and control information;
means for detecting an error in said address and control information based on said corresponding error detection information; and
means for providing an error indication in response to detecting said error.
